(19) United States
(12) Patent Application Publication
(10) Pub. No.: US 2011/0277705 A1
(43) Pub. Date: Nov. 17, 2011

(54) EQUINE FAECES COLLECTION SYSTEM

(76) Inventor: Jose Hernandez-Ramirez, Alcala de Henares (ES)

(21) Appl. No.: 13/146,235

(22) PCT Filed: Jan. 26, 2010
(86) PCT No.: PCT/ES2010/070040

§ 371 Date: Jul. 26, 2011

(30) Foreign Application Priority Data
Jan. 26, 2009 (ES) U200900132

(51) Int. Cl. A01K 23/00

(52) U.S. Cl. 119/868

(57) ABSTRACT

The equine faeces collection system includes a tubular excrement collection device (2) with a faeces outlet (70) connected to the collection deposit intake (7) and an intake mouth (13) adapted to face the animal's anal area directing the excrement towards the deposit. The collection device (2) has a first collection area (8) with an outlet mouth connected (70) to the collection deposit intake (7), and a second collection area (11) with an intake mouth (13) which is coupled to the first area (8) to move from a rest position to a collection position in which the intake mouth (13) is facing the animal's anal area, where the intake mouth is located over the outlet mouth so that the excrement falls towards the faeces deposit by gravity. In addition, a turbine (9) moved by an electrical motor (10) could be mounted inside the first collection area (8) to help drag the faeces towards the deposit (7).

### BACKGROUND OF THE INVENTION

The invention relates to a system for the collection of equine faeces.

Document ES 1 033 361 describes a deposit system for the collection of faeces formed as a truss positioned around the animal's anus and capable of being replaced in its rear, so that when the animal defecates, the faeces remain in its interior. The main disadvantage of this system is its lack of hygiene, since the animal's body will remain exposed in contact with the faeces.

In turn, document ES 1069640 describes an article to collect animal deposits styled as a disposable diaper. The basic problems with this solution arise when placing the article on animals of large dimensions, the discomfort caused to the animal and the odours caused by the lack of isolation.

### SUMMARY OF THE INVENTION

Based on the above-explained prior art, the present invention, as explained in this description, refers to an equine faeces collection system equipped for the collection, treatment and isolation of animal faeces hygienically, without causing the animal any discomfort.

According to the invention, this objective is achieved by an excrement-collecting device essentially in tubular shape having a faeces outlet connected to the intake of the collection deposit and an intake mouth adapted to face the animal's anal area, so that the excrement is directed to such deposit.

According to an additional aspect of the invention, the collection device has a first collection area including the outlet mouth which is connected to the collection deposit intake and a second collection area which includes the intake mouth linked to the first area to move from a rest position to a collection position in which the intake mouth is facing the animal's anal area and the intake mouth is located over the outlet mouth so that the excrement moves towards the faeces deposit by gravity.

An additional advantage can be achieved by providing the first collection area with an internal turbine driven by a motor to at least drag the faeces towards the deposit.

According to another advantage of the invention, the motor includes a receiver for remotely operating the same.

According to a further feature of the invention, a drive and detection device is provided to operate the motor and to detect when the animal lifts its tail prior to defecating, the drive and detection device is operationally coupled on the back of the animal.

According to an aspect of the invention, the drive and detection device includes a support plate on which a control transmitter with a drive switch and an articulated handle to operationally actuate the switch is fixedly mounted. The articulated handle has a free end proximate to the animal's tail so that when the animal lifts its tail prior to defecating, the transmitter control switch is actuated so that the motor begins to rotate and the faeces can be dragged by the turbine towards the deposit.

Another advantage according to the invention, is having the support plate endowed with an articulated appendix to fit the support on the back of the horse.

According to another aspect of the invention, a tubular section which is coupled to the first and second collection areas between the first and second tubular areas of the collection device to orient them adequately so that the intake mouth of the second area faces the animal's anal area perfectly.

According to an aspect of the invention, additional tubular sections are provided to increase the length of the tubular collection device.

An additional advantage can be achieved by providing a device to regulate the orientation of the tubular section provided between the first and second area.

In another aspect of the invention, the equine faeces collection system is connected to the animal with the aid of a cavalry harness.

Another of the invention's additional features is that the turbine blades are adapted to finely crush and break down the animal's faeces for their subsequent use as compost or biofuel.

According to another aspect of the invention, a bag is connected to the outlet mouth of the deposit for receiving the faeces or the result of its treatment.

According to still another aspect of the invention, a door is provided in the upper part of the deposit for extracting the faeces or the mass resulting from its treatment.

According to an aspect of the invention, the equine faeces collection system is coupled to a carriage with an adjustable setting system.

According to a further aspect of the invention, the equine faeces collection system can have several intake mouths connected to the collection device.

According to one aspect of the invention, the motor can be powered with the energy generated by the carriage wheel movement.

### BRIEF DESCRIPTION OF THE DRAWINGS

Further features and advantages of the invention will become apparent from the following description in conjunction with the attached drawings, referring but not limited to a preferred embodiment in which:

FIG. 1 shows a schematic of the equine faeces collection system mounted on the animal.

FIG. 2 shows in detail the drive and detection device.

FIG. 3 shows in detail the excrement collection device.

FIG. 4 shows the faeces deposit.

FIG. 5 represents the articulated section.

FIG. 6 represents the expansion tubular sections and the intake mouth.

FIG. 7 represents schematically the rest and collection positions of the collection device.

FIG. 8 represents the carriage coupling mechanism.

### DETAILED DESCRIPTION OF THE INVENTION

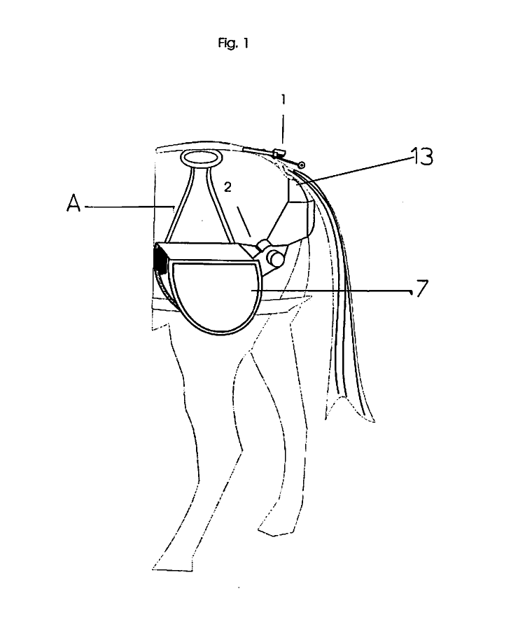

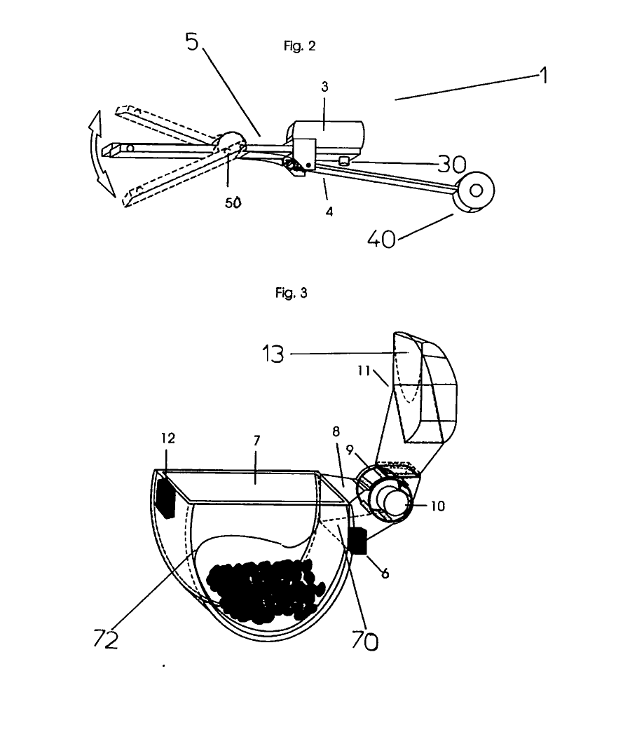

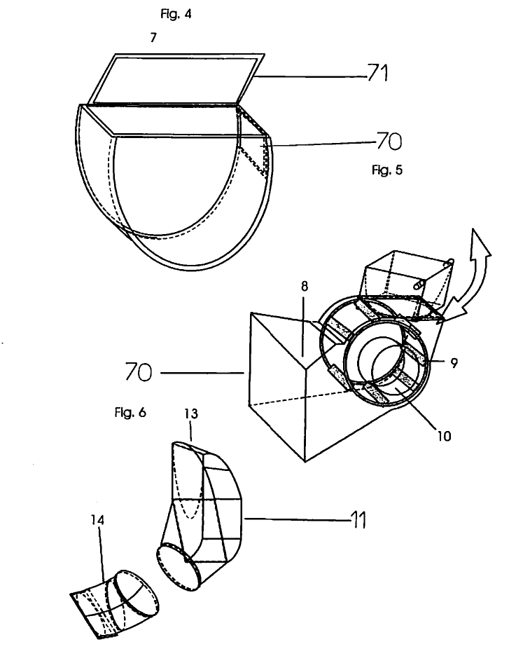

As can be seen in FIGS. 1 and 3, the equine faeces collection system comprises a faeces collection device 2 having an essentially tubular shape with an intake mouth 13 facing an animal's anal area for receiving its faeces when the animal defecates, which is then directed to a collection deposit 7.

The collection device 2 as shown in FIGS. 3 and 5, moves from a rest position to a collection position, in other words, with the intake mouth 13 facing the animal's anal area. To do so, the collection device 2 has a first collection area 8 shaped as an inverted funnel ending in an outlet mouth 70 towards a deposit collection intake 7. The collection area 8 is also coupled to a second collection area 11 directing the intake mouth 13 to the animal's anal area.

It can be seen that, in the collection position, the intake mouth 13 of the second collection area 11 is located at a higher position than the outlet mouth 70 of the first collection area 8, so that the faeces move towards the deposit 7 by gravity.

However, in order to aid the movement of faeces from the intake mouth 13 to the deposit 7, the first collection area 8 contains a turbine controlled by a motor 10 that when activated the turbine blades push the faeces towards the deposit 7.

The motor 10 can be activated by a receiver (6) that can be remotely controlled. Alternatively, a wired connection could also be used.

Additionally, according to the present invention, the system can incorporate a drive and detection device 1 to actuate the motor 10. The drive and detection device 1 includes a support plate 5 on which is fixedly mounted a control transmitter 3 with a drive switch 30 and an articulated handle 4 to operationally face the drive switch 30. The articulated handle 4 has a free end 40 proximate to the animal's tail and when the animal lifts its tail prior to defecating, the switch 30 is actuated and the control transmitter 3 sends a signal so that the motor 10 begins to rotate and the faeces are dragged by the turbine 9 towards the deposit 7.

The support plate 5 has an articulated appendix 50 which tilts adjusting the support plate 5 to the back of the animal, so that the articulated handle 4 actuates the activation switch 30 when the animal moves its tail. This, is provided to adjust its placement on the animal without annoying the animal.

In order to provide the collection device 2 with more mobility between its first 8 and second 11 tubular areas, a tubular section 16 is coupled to the first and second collection areas to orient them adequately so that the intake mouth 13 of the second area 11 faces the animal's anal area perfectly as shown in FIG. 7.

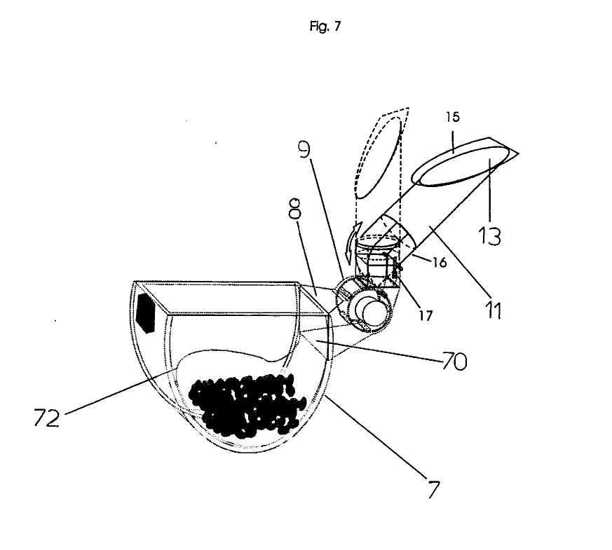

If as a result of installing the system on carriages the collection device 2 needs to have a greater length, additional sections of tubing 14 are provided as shown in FIG. 6.

A device 17 is provided if there is a need to adjust the orientation of the second area 11 to face the animal's anal area when placing the collection device 2.

When the faeces collection system is installed, it is positioned on the animal's side and bounded to the animal by means of a cavalry harness A.

According to a preferred embodiment of the invention, the turbine blades 9 are designed to finely crush the faeces and directing them into the deposit 7 ready for subsequent use as compost or biofuel.

At least one door 71 is provided in the upper part of the deposit 7 to facilitate collection of faeces or the resulting crushed product.

It is also possible to connect a bag 72 to the outlet mouth 70 of the deposit 7.

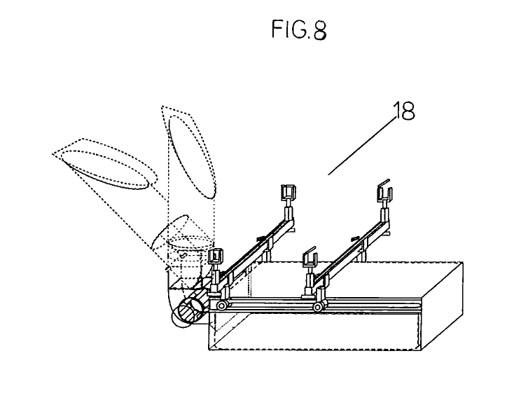

Finally, as shown in FIG. 8, it is possible to connect the equine faeces collection system to a carriage by means of device 18. In this embodiment, the motor 10 could be powered with the energy produced by the carriage wheels movement and there can be several collection devices 2 connected to the deposit 7.

As can be easily understood by persons of ordinary skill in the art, the above-described is merely illustrative of preferred embodiments of the invention. Any type of technical modifications are possible without departing from the spirit and scope of the invention. Thus, the invention will only be limited by the scope of the appended claims.

1. An equine faeces collection system comprising:
a deposit (7) for collecting faeces; and
a tubular excrement collection device (2) having a faeces outlet (70) connected to an intake of said deposit (7) and an intake mouth (13) adapted to face an animal's anal area so that the faeces are directed towards said deposit (7), wherein said excrement collection device (2) further comprises a first collection area (8) including said faeces outlet (70), and a second collection area (11) including said intake mouth (13) which is coupled to said first collection area (8) to allow movement from a rest position to a collection position in which the intake mouth (13) is facing the animal's anal area and the intake mouth is located atop said faeces outlet so that the faeces fall towards the deposit by gravity.

2. The equine faeces collection system of claim 1, wherein said first collection area (8) further comprises an internal turbine (9) moved by an electrical motor (10) to drag said faeces towards said deposit (7).

3. The equine faeces collection system of claim 2, wherein the electrical motor (10) includes a receiver (6) for remotely controlling said electrical motor (10).

4. The equine faeces collection system of claim 2, further comprising a drive and detection device (1) for activating said electrical motor (10) and for detecting when the animal lifts its tail at the time of defecating, said drive and detection device (1) being operationally coupled on the animal's back.

5. The equine faeces collection system of claim 4, wherein the drive and detection device (1) comprises a support plate (5) positioned on the back of the animal, said support plate (5) has fixedly mounted a control transmitter (3) having a drive switch (30) and an articulated handle (4) to operationally actuate said switch (30), said articulated handle (4) has a free end (40) proximate to the animal's tail and when the animal lifts its tail prior to defecating, said switch (30) is actuated so that the motor (10) begins to rotate and the faeces can be dragged by the turbine (9) towards the deposit (7).

6. The equine faeces collection system of claim 5, wherein the support plate (5) comprises an articulated appendix (50) to adjust said support plate on the back of the animal.

7. The equine faeces collection system of claim 1, comprising a tubular section (16) coupled between the first (8) and the second (11) collection areas of said collection device (2) to mutually orient them so that the intake mouth (13) of the second collection area (11) exactly faces the animal's anal area.

8. The equine faeces collection system of claim 1, further comprising additional sections of tube (14) to increase the length of the tubular collection device (2).

9. The equine faeces collection system of claim 7, comprising a device (17) for regulating the orientation of the tubular section (16) provided between the first (8) and second (11) collection areas of the collection device (2).

10. The equine faeces collection system of claim 1, wherein the system is bound to the animal by means of a cavalry harness (A).

11. The equine faeces collection system of claim 2, wherein the turbine blades (9) are adapted to at least one of: finely crush and break down the animal's faeces for their subsequent use as compost or biofuel.

12. The equine faeces collection system of claim 1, wherein said the deposit (7) comprises a bag (72) connected to the outlet mouth (70).

13. The equine faeces collection system of claim 1, wherein the deposit (7) comprises a door (71) in its upper section.

14. The equine faeces collection system of claim 1, wherein the system is capable of being connected to a carriage by an adjustable setting system (18).

15. The equine faeces collection system of claim 1, wherein the system is capable of having a plurality of collection devices (2) connected to the deposit (7).

16. The equine faeces collection system of claim 2, wherein the motor (10) is capable of being powered from the energy generated by the carriage's wheels movement.
